(19) United States
(12) Patent Application Publication
(10) Pub. No.: US 2021/0209541 A1
(43) Pub. Date: Jul. 8, 2021

(54) DEVICE, METHOD AND COMPUTER PROGRAM FOR OPERATING A SHIP

(71) Applicant: Fraunhofer-Gesellschaft zur Förderung der angewandten Forschung e.V., München (DE)

(72) Inventors: Anisa Rizvanolli, Hamburg (DE); Ole John, Hamburg (DE)

(21) Appl. No.: 17/207,043

(22) Filed: Mar. 19, 2021

Related U.S. Application Data
(63) Continuation of application No. PCT/EP2019/075230, filed on Sep. 19, 2019.

(30) Foreign Application Priority Data
Sep. 26, 2018 (DE) 10 2018 216 514.9

(51) Int. Cl. G06Q 10/06; G05B 17/02; G06Q 10/10; G07C 5/00; G06Q 10/00; G06Q 10/04; B63B 79/40; G01C 21/20

(52) U.S. Cl. CPC G06Q 10/063116; G05B 17/02; G06Q 10/1091; G07C 5/008; G01C 21/203; G06Q 10/20; G06Q 10/047; B63B 79/40; G07C 5/006

(57) ABSTRACT

Method of operating a ship, including the step of obtaining a ship itinerary by means of a processing unit of the ship, the ship itinerary including one or more defined ship operating conditions for one or more sections of a journey of the ship. During the journey, the method may detect a current ship operating condition of the ship, the current ship operating condition being temporally associated with one of the defined ship operating conditions of the ship itinerary. In addition, the method may compare the current ship operating condition to the temporally associated, defined ship operating condition of the ship itinerary so as to calculate an updated ship itinerary in response to deviations of the current ship operating condition from the defined ship operating condition, the calculation of the updated ship itinerary being based on a model which takes into account operation-relevant parameters for the operation of the ship.

### CROSS-REFERENCES TO RELATED APPLICATIONS

This application is a continuation of copending International Application No. PCT/EP2019/075230, filed Sep. 19, 2019, which is incorporated herein by reference in its entirety, and additionally claims priority from German Application No. DE 10 2018 216 514.9, filed Sep. 26, 2018, which is incorporated herein by reference in its entirety.

Embodiments of the invention relate to a device, a method and a computer program for operating a ship.

### BACKGROUND OF THE INVENTION

To ensure safe and trouble-free operation of a ship, information specific to the journey and to safety is nowadays manually established for each ship and each route. Despite the dependence on many factors, this decision is primarily based on experiential values and on an assessment made on the part of planners in charge that is not clearly quantifiable. In particular, establishing the information is based on a predefined route of the ships, so that reliable operation of the ship is ensured for said route. Changes in the operating condition of the ship cannot be incorporated.

Against this background, there is a need for a concept enabling an improved compromise between optimized, efficient and safe operation of a ship, cost reduction, adherence to regulations specific to navigation as well as facilitated verification of compliance with the regulations specific to navigation.

### SUMMARY

According to an embodiment, a method of operating a ship may have the steps of: obtaining a ship itinerary by means of a processing means of the ship, the ship itinerary including one or more defined ship operating conditions for one or more sections of a journey of the ship; during the journey, detecting a current ship operating condition of the ship, the current ship operating condition being temporally associated with one of the defined ship operating conditions of the ship itinerary, and wherein the current ship operating condition is detected by means of an interface of the processing means with an electronic sea map, with machine sensors, with working-hour terminals of the crew, and/or with the land station; and wherein the one or more defined ship operating conditions and the current ship operating condition include states of machines, current and/or future positions of the ship, and/or external influences; comparing the current ship operating condition to the temporally associated, defined ship operating condition of the ship itinerary so as to calculate an updated ship itinerary in response to deviations of the current ship operating condition from the defined ship operating condition, wherein calculating the updated ship itinerary is based on a model which takes into account operation-relevant parameters for the operation of the ship; wherein the ship itinerary and/or the updated ship itinerary includes a task schedule for a crew of the ship for the journey, and wherein the model takes into account maintenance times, so that the task schedule for the crew of the ship indicates maintenance times that may be performed on the machines of the ship.

According to another embodiment, a method of operating a ship may have the steps of: transmitting a ship itinerary from a land station to a processing means of the ship, the ship itinerary including one or more defined ship operating conditions for one or more sections of a journey of the ship; during the journey, detecting a current ship operating condition of the ship, the current ship operating condition being temporally associated with one of the defined ship operating conditions of the ship itinerary, and wherein the current ship operating condition is detected by means of an interface of the processing means with an electronic sea map, with machine sensors, with working-hour terminals of the crew, and/or with the land station; and wherein the one or more defined ship operating conditions and the current ship operating condition include states of machines, current and/or future positions of the ship, and/or external influences; comparing the current ship operating condition to the temporally associated, defined ship operating condition of the ship itinerary so as to calculate an updated ship itinerary in response to deviations of the current ship operating condition from the defined ship operating condition, wherein calculating the updated ship itinerary is based on a model which takes into account operation-relevant parameters for the operation of the ship, and wherein the ship itinerary and the updated ship itinerary include a task schedule for a crew of the ship for the journey, and wherein the model takes into account maintenance times, so that the task schedule for the crew of the ship indicates maintenance times that may be performed on the machines of the ship.

According to another embodiment, a non-transitory digital storage medium may have a computer program stored thereon to perform the inventive method, when the program runs on a computer.

According to yet another embodiment, a device for operating a ship may have:

a processing means of the ship that is configured
to obtain a ship itinerary, the ship itinerary including one or more defined ship operating conditions for one or more sections of a journey of the ship;
to detect, during the journey, a current ship operating condition of the ship, the current ship operating condition being temporally associated with one of the defined ship operating conditions of the ship itinerary; and
to detect the current ship operating condition by means of an interface with an electronic sea map, with machine sensors, with working-hour terminals of the crew, and/or with the land station; and
wherein the one or more defined ship operating conditions and the current ship operating condition include states of machines, current and/or future positions of the ship, and/or external influences;
to compare the current ship operating condition to the temporally associated, defined ship operating condition of the ship itinerary so as to calculate an updated ship itinerary in response to deviations of the current ship operating condition from the defined ship operating condition,

the device being configured to calculate the updated ship itinerary on the basis of a model which takes into account operation-relevant parameters for the operation of the ship;

wherein the ship itinerary and/or the updated ship itinerary includes a task schedule for a crew of the ship for the journey, and

wherein the model takes into account maintenance times, so that the task schedule for the crew of the ship indicates maintenance times that may be performed on the machines of the ship.

According to still another embodiment, a device for operating a ship may have:

a processing means of the ship that is configured
to obtain a ship itinerary, the ship itinerary including one or more defined ship operating conditions for one or more sections of a journey of the ship;
to detect, during the journey, a current ship operating condition of the ship, the current ship operating condition being temporally associated with one of the defined ship operating conditions of the ship itinerary, and
to detect the current ship operating condition by means of an interface with an electronic sea map, with machine sensors, with working-hour terminals of the crew, and/or with the land station; and
wherein the one or more defined ship operating conditions and the current ship operating condition include states of machines, current and/or future positions of the ship, and/or external influences;
to compare the current ship operating condition to the temporally associated, defined ship operating condition of the ship itinerary so as to calculate an updated ship itinerary in response to deviations of the current ship operating condition from the defined ship operating condition,

the device being configured to calculate the updated ship itinerary on the basis of a model which takes into account operation-relevant parameters for the operation of the ship, and

wherein the ship itinerary and the updated ship itinerary include a task schedule for a crew of the ship for the journey, and

wherein the model takes into account maintenance times, so that the task schedule for the crew of the ship indicates maintenance times that may be performed on the machines of the ship.

According to one embodiment, a ship may have an inventive device.

An embodiment relates to a method of operating a ship which comprises the step of obtaining a ship itinerary by means of a processing means of the ship. In this context, the ship itinerary may be transmitted, for example, from a land station to the processing means of the ship.

Alternatively, the ship itinerary may be transmitted to the processing means of the ship, for example, via a USB stick, via app and/or by an input via a user interface of a device on the ship which performs the method. The ship itinerary may comprise one or more defined ship operating conditions for one or more sections of a journey of the ship. The journey of the ship may be split up, e.g., in the sections of seafaring and port lay times. The one or more sections of the ship's journey may also define regular time intervals of, e.g., five minutes, 30 minutes, an hour or a day, and may temporally map the entire journey of the ship. However, it is also possible for the ship itinerary to comprise only one section which may include, e.g., the entire journey of the ship. During this one section or said several sections of the journey, the ship itinerary may comprise one or more defined ship operating conditions which temporally map, e.g., the entire journey of the ship or which define, at regular or irregular time intervals, an operating condition of the ship during the journey. During the journey, a current ship operating condition of the ship may be detected and may be temporally associated with one of the defined ship operating conditions of the ship itinerary.

For example, the current ship operating condition may be detected, e.g., at one point in time of the journey and may be associated with a defined operating condition of the ship itinerary at the same point in time. Optionally, it is possible for the current ship operating condition to comprise the ship operating condition of the ship at a point in time of the detection and at subsequent points in time. It is therefore possible that the current ship operating condition may define the ship operating condition of the ship for time periods within a section or for several sections of the ship's journey, which enables the current ship operating condition to be associated with one or more of the defined ship operating conditions of the ship itinerary, which may define the ship operating condition during the same time period as the current ship operating condition. In other words, it is thus made possible to compare only specific points in time or sections of a predefined journey to a current journey, which is why deviations may be determined very effectively by means of the method while involving little computational expenditure.

In accordance with an embodiment, both the one or the several defined ship operating conditions and the current ship operating condition completely map the journey of the ship (reality), which is why, e.g., the current ship operating condition may be temporally associated with all of the defined ship operating conditions. This enables effectively linking the defined ship operating conditions to the current ship operating condition for the entire journey of the ship, which is why current deviations in the journey may be quickly detected and, therefore, re-planning of the journey of the ship is facilitated.

The method of operating the ship may compare the current ship operating condition to the temporally associated, defined ship operating condition of the ship itinerary so as to calculate an updated ship itinerary in response to deviations of the current ship operating condition from the defined ship operating condition. Calculation of the updated ship itinerary is based, e.g., on a model which takes into account operation-relevant parameters for the operation of the ship.

The present invention is based on the finding that by calculating an updated ship itinerary on the basis of deviations of the current ship operating condition from the temporally associated, defined ship operating condition enables that short-term events which might interfere with operation of the ship can be taken into account by the method, so that the updated ship itinerary may ensure smooth, efficient and safe operation of the ship. The model on which calculation of the updated ship itinerary is based may enable integrating the deviation of the current ship operating condition from the temporally associated, defined ship operating condition of the ship itinerary into the updated ship itinerary such that operation of the ship may be maintained and that as few delays as possible, or no delays, and/or breakdowns occur in the operation of the ship. Within this context, in that the operation-relevant parameters are taken into account, the model may adhere to regulations specific to navigation and may provide the updated ship itinerary which complies with the regulations specific to navigation and/or which optionally indicates any occurrence where regulations specific to navigation not having been complied with. Here, the model is designed, for example, to optimize the updated ship itinerary to the effect that operation of the ship is efficiently and safely maintained when the deviations occur. Within this context, the model may be designed, e.g., to at least partly, if possible, allow deviations which are within tolerated deviations of regulations specific to navigation so as to maintain operation of the ship and to avoid, e.g., delays in the operation of the ship. The regulations specific to navigation comprise, e.g., framework conditions within which deviations from regulations are made possible in exceptional situations.

It may thus be stated that the method of operating a ship enables optimized, efficient and safe operation of the ship while adhering to regulations specific to navigation and enables facilitated verification of compliance with the regulations specific to navigation by adapting the ship itinerary during the journey of the ship on the basis of deviations in the route. Moreover, the method of operating the ship may lower cost since the model for calculating the updated ship itinerary may take into account regulations specific to navigation, e.g., by means of the operation-relevant parameters, and may thus avoid fines arising in the event of non-compliance of the regulations specific to navigation.

In accordance with an embodiment, the ship itinerary and/or the updated ship itinerary comprises a task schedule for a crew of the ship for the journey. The ship itinerary and the updated ship itinerary may thus determine and document tasks, activities and periods of rest of the crew in the task schedule for each of the sections of the journey so as to ensure smooth operation of the ship.

In accordance with an embodiment, the operation-relevant parameters of the model may comprise maintenance times, seafaring times, port lay times and/or safety-relevant parameters such as crew resting periods. The seafaring times and port lay times enable the ship to dock at a port in time and/or enable tasks to be performed during seafaring times and port lay times to be planned by the model such that no or only minor delays will occur in the operation of the ship. For example, the method may also take into account maintenance times in the model, as a result of which the updated ship itinerary indicates, in the task schedule for the crew of the ship, e.g. when and by who maintenance works are ideally to be performed on the machines of the ship that are indicated by the updated ship itinerary so that the ship may make its journey safely and with reduced operational disturbances. Moreover, the model may comprise safety-relevant parameters such as crew resting periods, for example, which are defined by regulations specific to navigation and are to be complied with so as to ensure safe operation of the ship since in the event of non-adherence to the crew resting periods, overtiredness of the crew may occur, for example, and thus, operation of the ship will be possible only to a limited extent and regulations specific to navigation will not be complied with, which may increase cost of operating the ship and may possibly result in accidents.

In accordance with an embodiment, the model is configured to allow, in an exceptional state, deviations from the safety-relevant parameter “crew resting periods” so as to maintain operation of the ship. In other words, the model may be designed, e.g., to violate the safety-relevant parameter “crew resting periods” in an exceptional state so as to maintain operation of the ship. An exceptional state may include, e.g., deviation of the current ship operating condition from the temporally associated, defined ship operating condition of the ship itinerary, e.g., due to damage to the machine/the ship or due to a delayed arrival at the port. Thus, the model has to maintain the priority of operating the ship and, e.g., in the event of damage to the machine/ship, of assigning tasks of removing the damage to crew members who, according to the regulations specific to navigation, are in need of the crew resting period at this point in time, so that the ship may continue its operation with only minor or no limitations. Likewise, the model may, for example, ascertain an exceptional situation in the event of a delayed arrival at a port, and may thus calculate—for crew members who, according to the regulations specific to navigation, are in need of a specific crew resting period—deviating crew resting periods which lie within deviations that are tolerated according to the regulations. As a result, the model may assign tasks, within the task schedule, to said crew members so that a reduced port lay time may be complied with while all tasks that need to be performed are performed, and so that operation of the ship is not or hardly delayed. As a result, the method of operating the ship is optimized and designed to be very efficient.

In accordance with an embodiment, at least one of the operation-relevant parameters may be adapted on the basis of a deviation of the current ship operating condition from the temporally associated, defined ship operating condition of the ship itinerary. Thus, the deviations may indicate, for example, that the seafaring times or port lay times have changed and therefore have to be adapted, and/or that events have occurred due to which the maintenance times and/or crew resting periods should be adapted so that the deviations will not interfere with the operation of the ship and so that, therefore, optimized, efficient and safe operation of the ship can be ensured. By adapting the operation-relevant parameters on the basis of the deviations, the model may take the deviations into account and may thus calculate an updated ship itinerary which ensures operation of the ship despite the deviations.

In accordance with an embodiment, the model may take into account whether tasks of the task schedule for the crew may be temporally split up and/or be split up among several crew members. Consequently, when the deviations indicate that urgent tasks need to be accomplished now and cannot be postponed, e.g., to a later point in time, the model may, e.g., postpone other simultaneous tasks, according to the task schedule of the ship itinerary, to a different point in time or split them up among other crew members. Thus, activities that result from the deviations may be performed without any or with only minor restrictions of the operation of the ship. Thus, the method can assign task and activities to crew members on the basis of the model, with the updated ship itinerary, and can determine when they are to be performed. In this manner, optimized, efficient and safe operation of the ship can be ensured.

In accordance with an embodiment, calculation of the updated ship itinerary on the basis of the model may be effected within less than five minutes upon ascertainment of the deviations of the current operating condition from the temporally associated, defined ship operating condition of the ship itinerary. In accordance with an embodiment, the time period may also be less than a minute, 30 seconds or one second, as a result of which the ship itinerary may be, e.g., dynamically adapted in real time to the updated ship itinerary. Thus, the method may react very quickly to deviations of the current ship operating condition from the temporally associated, defined ship operating condition of the ship itinerary and may thus ensure efficient and safe operation of the ship at any point in time of the ship's journey.

In accordance with an embodiment, the current ship operating condition may be detected by means of an interface of the processing means with an electronic sea map, with machine sensors, with the crew's working-hours terminals and/or with the land station. Since the processing means has access to the electronic sea map, the current ship operating condition may include, e.g., a position of the ship, a route of the ship, weather, war, distress at sea, environmental protection zones, piracy, etc. for the ship's journey. By means of the interface with the machine sensors, the current ship operating condition can indicate whether or not a machine of the ship should be maintained, is damaged, has failed, or is working perfectly. By means of the crew's working-hours terminals, the processing means can automatically register which work is performed by which crew member at which point in time. By means of the interface with the land station, information that is relevant to the operation of the ship such as, e.g., a pilot being delayed, a change in the route of the ship, or other requirements placed upon the operation of the ship of the land stations, may be transmitted. Thus, the method can automatically detect, via the interfaces, the current ship operating condition and can, on the basis thereof, compare the current ship operating condition to the temporally associated, defined ship operating condition of the ship itinerary so as to verify whether or not the current ship operating condition exhibits deviations from the defined ship operating condition. Therefore, the method can, via the interfaces of the processing means, query and/or verify manifold events which may influence operation of the ship, and can incorporate them in calculating the updated ship itinerary.

In accordance with an embodiment, the current ship operating condition may comprise current, possibly, e.g., simultaneous and/or future working hours and/or tasks of the crew, current states of machines, current and/or future positions of the ship, and/or external influences. For example, the processing means can detect, via the interface with the crew's working-hours terminals, current and past working hours and tasks performed by crew members, and can determine, on the basis said information, current and future working hours and tasks of the crew, which the processing means may provide in the form of the current ship operating condition. Moreover, the current ship operating condition may comprise the current state of the machines of the ship. The current ship operating condition may display the ship's journey with the current and future positions of the ship, e.g., as of the time of detecting the current ship operating condition. As external influences, the current ship operating condition may comprise, e.g., an interaction with land, such as a pilot boarding the ship, or interactions occurring on the water, such as influences caused by war, weather, distress at sea, etc. Thus, it is made possible to detect, by means of the method, manifold unforeseen events during the ship's operation, and to prevent said events from interfering with the ship's operation.

In accordance with an embodiment, the current ship operating condition may be detected at certain points in time or upon events. For example, the method may detect the current ship operating condition every five minutes, once per hour, once a day or upon occurrence of an event, such as a signal from the machines of the ship, from the working-hours terminals of the crew, from the electronic sea map, or from the land station. Thus, the method is designed to automatically and autonomously optimize operation of the ship, and to configure it to be efficient and safe. Optionally, it is also possible for the current ship operating condition to be continually detected during the entire journey of the ship by means of the method.

In accordance with an embodiment, the ship itinerary and/or the updated ship itinerary may depend on a route of the ship. For example, the task schedule for the crew of the ship may depend on the one or more sections of the journey, such as a port docking section and a seafaring section. For example, the one or more defined ship operating conditions of the ship itinerary and of the updated ship itinerary during a sea journey may, e.g., deviate from the one or more defined ship operating conditions during a port lay time. Thus, the method may optimize operation of the ship and configure it to be efficient and safe in a manner that is individually adapted to the ship's route.

An embodiment provides a computer program having a program code for performing the method, when the program runs on a computer.

An embodiment provides a device for operating a ship which comprises a processing means of the ship which may be configured to obtain a ship itinerary from, e.g., a land station, a USB stick, an app and/or via an input into a user interface of a device on the ship, the ship itinerary comprising one or more defined ship operating conditions for one or more sections of a journey of the ship; so as to detect a current ship operating condition of the ship during the journey, the current ship operating condition being temporally associated with one of the defined ship operating conditions of the ship itinerary; and to compare the current ship operating condition to the temporally associated, defined ship operating condition of the ship itinerary so as to calculate an updated ship itinerary in response to deviations of the current ship operating condition from the defined ship operating condition. In addition, the device may be configured to calculate the updated ship itinerary on the basis of a model which takes into account operation-relevant parameters for the ship's operation. The ship itinerary and/or the updated ship itinerary may comprise, e.g., a task schedule for a crew of the ship for the journey.

With regard to the schematic figures depicted, it shall be noted that the functional blocks depicted may be understood both as elements or features of the inventive device and as corresponding method steps of the inventive method, and that corresponding method steps of the inventive method may also be derived therefrom.

### BRIEF DESCRIPTION OF THE DRAWINGS

Embodiments of the present invention will be detailed subsequently referring to the appended drawings, in which:

FIG. 1 shows a schematic representation of a device and of a method of operating a ship in accordance with an embodiment of the present invention;

FIG. 2 shows a schematic representation of a task schedule for a crew of a ship in accordance with an embodiment of the present invention;

FIG. 3 shows a block diagram of a method of operating a ship in accordance with an embodiment of the present invention;

FIG. 4 shows a schematic representation of an application of a method of operating a ship in accordance with an embodiment of the present invention;

FIG. 5 shows a schematic representation of an application of a method comprising interaction with a land station in accordance with an embodiment of the present invention;

FIG. 6 shows a schematic representation of an application of a method with a very dense series of ports in accordance with an embodiment of the present invention; and

FIG. 7 shows a schematic representation of an application of a method upon an event on a ship in accordance with an embodiment of the present invention.

### DETAILED DESCRIPTION OF THE INVENTION

Before embodiments of the present invention will be explained in more detail below by means of the drawings, it shall be noted that elements, objects and/or structures that are identical or identical in function or in action are provided with identical or similar reference numerals in the different figures, so that the descriptions of said elements which are given in different embodiments are interchangeable and/or mutually applicable.

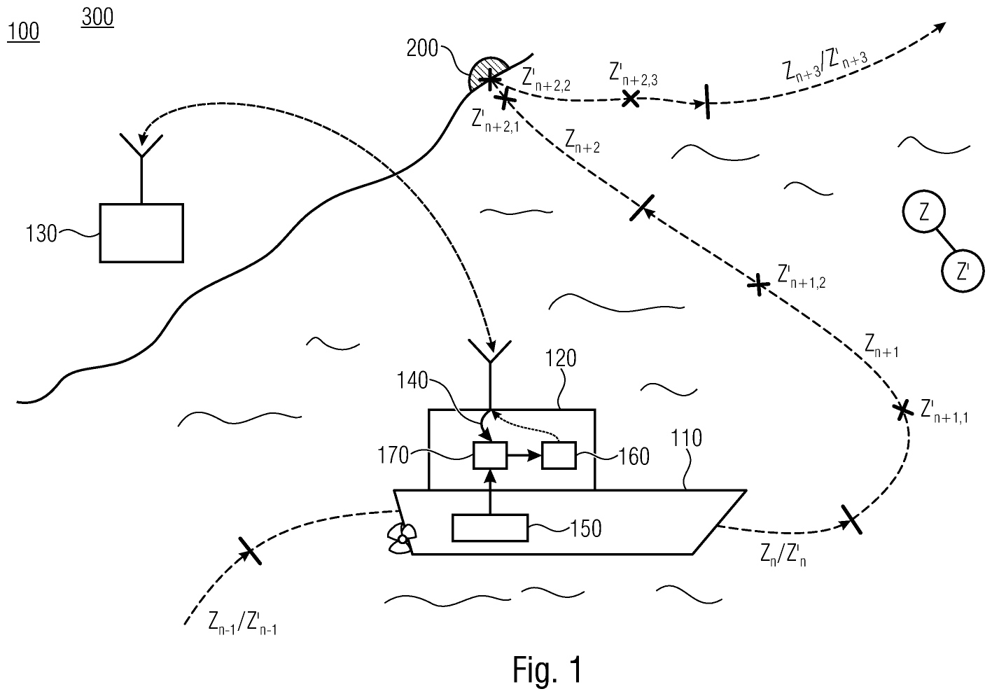

FIG. 1 shows a schematic representation of a device 100 for operating ship 110 comprising a processing means 120 of the ship 110 and a land station 130. The processing means 120 may be arranged in or on the ship 110, and the land station 130 may be arranged on main land. In accordance with an embodiment, the processing means 120 may communicate with the land station 130 via radio. For example, the device 100 may be configured to transmit a ship itinerary 140 from the land station 130 to the processing means 120.

The ship itinerary 140 may comprise one or several defined ship operating conditions Z′, Z′ₙ₋₁, Z′ₙ, Z′_{n+1,1}, Z′_{n+1,2}, Z′_{n+2,1}, Z′_{n+2,2}, Z_{n+2,3}, Z′ₙ₊₃ for one section Z or for several sections Z₀ to Zₖ (wherein k represents a positive integer) of a journey of the ship 110. Thus, the ship itinerary 140 may comprise one single section Z, for example, which may, e.g., represent the entire journey of the ship 110. Alternatively, the journey may also be split up into several sections Z₀ to Zₖ; in FIG. 1, the sections Zₙ₋₁ to Zₙ₊₃ are depicted, and the ship 110 is currently located within section Zₙ. Thus, FIG. 1 shows a section of the journey of the ship 110. The ship itinerary 140 may comprise, e.g. for the on section Z, a ship operating condition Z′ which defines a ship operating condition of the ship 110 for the entire section Z. Within this context, the defined ship operating condition Z′ may steadily define a ship operating condition of the ship 110 for each point in time of the section Z. Likewise, it is possible for section Zₙ₋₁ to have only one defined ship operating condition Z′ₙ₋₁, for the section Zₙ to have the defined ship operating condition Z′ₙ, and for section Zₙ₊₃ to have the defined ship operating condition Z′ₙ₊₃, and for each of the defined ship operating conditions Z′ₙ₋₁, Z′ₙ, Z′ₙ₊₃ to define the ship operating condition of the ship 110 for the respective corresponding section Zₙ₋₁, Zₙ, Zₙ₊₃. Alternatively, it is also possible for one of the sections Z₀ to Zₖ to have several defined ship operating conditions, such as section Zₙ₊₁, which may have the defined ship operating condition Z′_{n+1,1} and the defined ship operating condition Z′_{n+1,2}, and section Zₙ₊₂, which may have the defined ship operating conditions Z′_{n+2,1}, Z′_{n+2,2} and Z′_{n+2,3}. Within this context, for example, each of the defined ship operating conditions Z′_{n+1,1}, Z′_{n+1,2}, Z′_{n+2,1}, Z′_{n+2,2} and Z′_{n+2,3} may define a point in time and a change in the ship operating condition of the ship 110 on the journey.

In accordance with an embodiment, the one or more defined ship operating conditions may comprise working hours and tasks of the crew of the ship 110, positions of the ship 110 on the journey, and external influences for the one or more sections Z, Z₀ to Zₖ of the journey of the ship 110.

In accordance with an embodiment, the ship itinerary 140 may comprise a task schedule for a crew of the ship 110 for the journey. The task schedule may define, for the entire journey, i.e. for all sections of the journey of the ship 110, when and where on the ship 110 an activity is to be performed by a crew member, the task schedule assigning these activities with specific crew members at the specific points in time during the journey. In accordance with an embodiment, the defined ship operating condition may comprise the task schedule for the one or more sections. The task schedule may comprise, e.g. within the section Zₙ in the form of the defined ship operating condition Z′ₙ, tasks and/or activities of the crew on the ship 110 during a sea journey, and may comprise, within the section Zₙ₊₂, e.g. in the form of the defined ship operating condition Z′_{n+2,2}, works and/or activities of the crew in connection with a port 200 to which the ship 110 may be docked.

In accordance with an embodiment, the ship itinerary 140 may depend on the ship route Z. For example, the defined ship operating conditions Z′ₙ₋₁, Z′ₙ, Z′_{n+1,1}, Z′_{n+1,2} and Z′ₙ₊₃ may comprise ship operating conditions of the ship 110 that are specific to seafaring, and the defined ship operating conditions Z′_{n+2,1}, Z′_{n+2,2} and Z′_{n+2,3} may comprise port-specific ship operating conditions of the ship 110.

The processing means 120 of the device 100 may be configured, in accordance with an embodiment, to detect a current ship operating condition 150 of the ship 110 during the journey.

The current ship operating condition 150 may be temporally associated with one of the defined ship operating conditions, e.g., in accordance with FIG. 1 with the defined ship operating condition Z′ₙ of the ship itinerary 140. Thus, the current ship operating condition 150 may define, e.g., a ship operating condition of the ship 110 at the point in time of detecting the current ship operating condition 150, or may define it for the entire section Zₙ or for all points in time as of the time of detection up until the end of the journey (thus, e.g., for part of the section Zₙ, for the entire section Zₙ₊₁ to Zₖ). Thus, the current ship operating condition 150 may be associated—at least partly (e.g. at with the point in time of detection) or entirely—with the defined ship operating condition Z′ₙ, or at least partly with the defined ship operating condition Z′ₙ and all of the following defined ship operating conditions (e.g. from Z′_{n+1,1} to Z′ₖ), as the case may be.

In accordance with an embodiment, the processing means 120 may comprise interfaces with an electronic sea map, with machine sensors, with working-hours detection terminals of the crew, and with the land station 130 so as to detect the current ship operating condition 150. Thus, the current ship operating condition 150 may comprise current states of machines, which may be transmitted from the machine sensors of the ship 110 to the processing means 120. Thus, the current ship operating condition may indicate, for example, whether the machines are operating in a defect-free state, need maintenance, are damaged, or have failed. Moreover, the current ship operating condition 150 may indicate the current position or the current ship route of the ship 110, current weather, distress at sea, current war influences, etc., which the processing means 120 may gather from the electronic sea map, for example. Furthermore, the current ship operating condition may comprise external influences such as a pilot boarding the ship, or refueling of the ship, which the processing means may detect via the land station 130, for example. On account of the working-hours terminals of the crew, working hours and tasks performed by the crew may be automatically registered, as a result of which the current ship operating condition 150 comprises a work schedule, for example, which indicates which tasks have been performed at what time and by who of the crew up to the point in time of detecting the current ship operating condition 150. In this case, the current ship operating condition may be compared to, e.g., simultaneous defined ship operating conditions; the defined ship operating conditions may represent ship operating conditions of the ship 110 of the sections Z₀ to Zₙ, i.e. prior to detection (such as Zₙ₋₁, Zₙ, for example). Thus, it is possible that the current ship operating condition may be associated with defined ship operating conditions Zₙ₋₁, Zₙ prior to detection, or may even be associated with all of the defined ship operating conditions Z′, Z′ₙ₋₁, Z′ₙ, Z′_{n+1,1}, Z′_{n+1,2}, Z′_{n+2,1}, Z′_{n+2,2}, Z′_{n+2,3} and Z′ₙ₊₃ of the journey.

In accordance with an embodiment, the current ship operating condition 150 may be detected at specific point in times or upon events. For example, the current ship operating condition may be detected, e.g., every five minutes, once per hour or once a day. Alternatively, it is also possible for the current ship operating condition to be detected at the occurrence of defined events, such as upon a signal coming from the machine sensors of the ship 110, upon a signal coming from the land station 130, upon a signal coming from the electronic sea map, or upon a signal of the processing means 120, when the processing means 120 ascertains, for example by means of the working-hours terminals of the crew, that regulations specific to navigation have not been complied with and that this results in overworking of the crew, for example. The event of the electronic sea map may define, e.g., a change in the ship route of the ship 110, the signal from the machine sensors may define, e.g., a damage, a failure, or a maintenance that may be needed, and the signal of the land station may define, e.g., the pilot being delayed as an event in each case.

The processing means 120 may be configured to compare the current ship operating condition 150 to the temporally associated, defined ship operating condition Z′ₙ of the ship itinerary 140 so as to calculate an updated ship itinerary 160 in response to deviations of the current ship operating condition 150 from the defined ship operating condition Z′ₙ. Calculation of the updated ship itinerary 160 may be based on a model 170 which may take into account operation-relevant parameters for the operation of the ship 110.

Just like the ship itinerary, the updated ship itinerary 160 may comprise a task schedule for the crew of the ship 110. Moreover, the ship itinerary and/or the updated ship itinerary 160 may depend on the ship route Z. The updated ship itinerary 160 may comprise one or more updated defined ship operating conditions for the one or more sections Zₙ to Zₖ as from the time of detection of the current ship operating condition. Within this context, the one or more updated defined ship operating conditions may deviate from the one or more defined ship operating conditions Z′, Z′ₙ₋₁, Z′ₙ, Z′_{n+1,1}, Z′_{n+1,2}, Z′_{n+2,1}, Z′_{n+2,2}, Z′_{n+2,3} and Z′ₙ₊₃ since the deviations of the current ship operating condition 150 from the defined ship operating conditions Z′, Z′ₙ₋₁, Z′ₙ, Z′_{n+1,1}, Z′_{n+1,2}, Z′_{n+2,1}, Z′_{n+2,2}, Z′_{n+2,3} and Z′ₙ₊₃ have been taken into account in the updated ship itinerary.

The model 170 may be configured to adapt the ship itinerary 140, while taking into account operation-relevant parameters, such that operation of the ship 110 will not come to a standstill and/or will not be influenced to a large degree. The operation-relevant parameters of the model 170 may comprise maintenance times, seafaring times, port lay times and safety-relevant parameters such as crew resting periods. Said operation-relevant parameters may be predefined or may be automatically adapted by the processing means 120. The model 170 may be configured to optimize, within the maintenance times, seafaring times and port lay times, the work schedule of the ship itinerary while taking into account the deviations to the effect that, e.g., violations of working-hour regulations (according to regulations specific to navigation) are avoided and that the maintenance times, seafaring times, port lay times and crew resting periods are adhered to, whereby smooth and safe operation of the ship 110 may be ensured by the device 100. In accordance with an embodiment, the safety-relevant parameter “crew resting periods” may be violated by the model 170 in an exceptional state, e.g., in the case of damage being done to machines/the ship or of a delayed arrival at a port, so as to maintain operation of the ship 110. When this is no longer possible, the model 170 may tolerate minor violations of the crew resting periods in exceptional situations, even though it is configured to comply with the crew resting period as much as possible, for example, so as to, e.g., avoid standstill of the ship 110.

In accordance with an embodiment, at least one of the operation-relevant parameters may be adapted on the basis of the deviations of the current ship operating condition 150 from the defined ship operating condition Z′ₙ of the ship itinerary 140. For example, the deviations may indicate a change in the ship route Z, as a result of which the operation-relevant parameters of seafaring times and port lay times may possibly be adapted. If the deviations indicate overworking of the crew, for example (e.g., crew resting periods were not complied with), the maintenance times may be adapted and be postponed to a later point in time, for example, when the crew resting periods will again comply with the regulations specific to navigation.

Thus, the device 100 may automatically regulate operation of the ship 110 and may provide and adapt, e.g., instructions to the crew of the ship 110 an account of the current ship operating condition 150 without any human influence having to be exerted. For example, the device automatically generates the adapted work schedule that is provided to the crew and is followed by the crew; the work may be supervised by the device.

In accordance with an embodiment, the model 170 may take into account whether or not tasks of the task schedule for the crew may be temporally split up and/or be split up among several crew members. For example, the current ship operating condition 150 may indicate, for example, that a crew member unexpectedly had three work assignments during one night beyond envisaged points in time (e.g., indicated by the task schedule of the ship itinerary 140 regarding a defined ship operating condition) because of repair work on a machine, and now was supposed to adhere to the crew resting period so that regulations specific to navigation were complied with, as a result of which, however, activities envisaged, by the task schedule of the ship itinerary 140, to be performed by this crew member during the day cannot be adhered to. Said work may thus be split up among other crew members by the model in the updated ship itinerary 160 so that all tasks that need to be performed for operating the ship 110 are performed and, thus, operation of the ship 110 is ensured. Likewise, tasks of the task schedule may be temporally split up by the model, for example, if more urgent tasks are given priority, due to the deviations, over the formerly envisaged tasks in order to ensure operation of the ship 110. By adhering to the crew resting period, safe operation is ensured since accidents or operational errors due to overtiredness are avoidable. As a result, delays in operation of the ship can be avoided or minimized. Likewise, penalties imposed for non-compliance with regulations specific to navigation can be avoided.

In accordance with an embodiment, calculation of the updated ship itinerary 160 on the basis of the model 170 may be performed within less than 5 minutes, less than 1 minute or less than 1 second upon ascertainment of the deviations of the current ship operating condition 150 from the defined ship operating condition Z′ₙ of the ship itinerary 140. Thus, the device 100 may react very quickly to the deviations and may prevent operation of the ship 110 from being restricted.

In accordance with an embodiment, the model 170 is a static model by means of which, e.g., tasks for ensuring operation of the ship 110 may be defined and classified in a manner that is as close to reality as possible. Optionally, this model is not adapted. By means of a method which may be executed by the device 100, for example, only a task distribution is adapted (e.g., the task schedule); the tasks may nevertheless underlie a same structure, and the model is not changed by this, for example.

In other words, FIG. 1 also shows a method 300 of operating the ship 110 which adapts, on the basis of the task model 170, distribution of the tasks that are needed for operation of the ship while taking into account safety-relevant aspects such as, e.g., statutory resting periods (e.g., the crew resting period), in response to changes (e.g., the deviations of the current ship operating condition 150 from the defined ship operating condition Z′ₙ of the ship itinerary 140) of the ship operating condition. Interfaces with the electronic map system (e.g., the electronic sea map) and with further components of the integrated bridge system on board enable automatic detection of the changes in the journey of the ship (of the ship route Z). The journey may be stored in the electronic sea map (e.g., as a ship itinerary 140) and may unambiguously define a ship operating condition of the ship 110.

An advantage of the inventive approach is that very fast calculation and analysis of various strategies is enabled without directly negatively influencing operation of the ship. The model and the ensuing results offer reliable planning and decision support for various levels of personnel management on board and on land. Employment of the software additionally offers the possibility of making work processes and distributions of tasks more efficient and of optimizing working-hours management. In addition to reducing administrative expenditure, the safety of the ship is increased, in particular, e.g., by avoiding overworking of the crew.

It is possible, via the land station 130 or, on the ship 110, via the processing means 120, to manually or automatically define and modify basic data of the model 170 such as ports, ships, positions/ship route, tasks/activities, ship operating conditions, allocations to ship operating conditions, and a crew list in the device 100. Said basic information may be stored in the ship itinerary 140, for example, and may be adapted by the model 170, to form the updated ship itinerary 160, upon occurrence of unexpected situations deviating from the ship itinerary 140. Within this context, the model 170 may take into account operation-relevant parameters such as a category of the ship 110, ship route details such as seafaring times and port lay times, minimum/maximum numbers of crew members per position on the ship 110, regulations specific to navigation such as regulations concerning working hours, regulations concerning crew resting periods and/or regulations concerning a guarding cycle, and/or permitted exceptions to the regulations specific to navigation. For example, the processing means 120 may be configured to transmit, e.g., via radio, information such as the updated ship itinerary 160 to the land station 130. Moreover, information can be synchronized between the land station 130 and the processing means 120 via the radio link. The information may, e.g., be a report about working hours and crew resting periods or a report about reasons for non-compliance with regulations specific to navigation. Said information may be automatically detected and provided by the device 100.

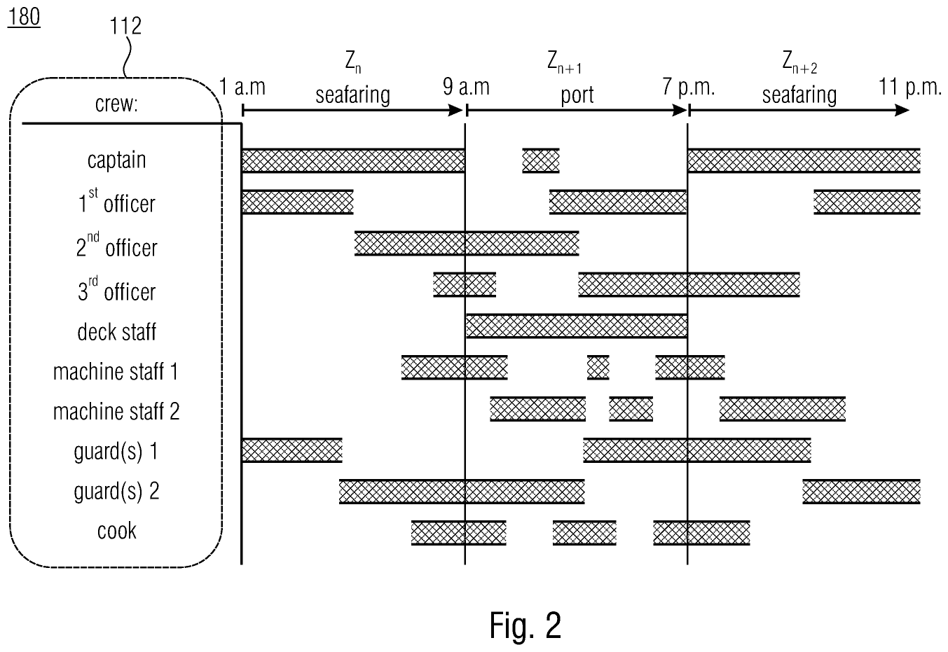

FIG. 2 shows a section of a task schedule 180 for a crew 112 of a ship for three sections Zₙ to Zₙ₊₂ of a journey. A ship itinerary or an updated ship itinerary may comprise the task schedule 180. Working hours of the crew 112 are entered in the task schedule 180 in the form of beams per section Zₙ to Zₙ₊₂ of the journey. The working-hours beams may indicate which activities are supposed to be performed on the ship by the respective member of the crew 112 at the respective point in time. For example, a crew resting period is entered between the individual beams. For example, the task schedule 180 depends on the ship route Zₙ to Zₙ₊₂. For example, fewer and different activities come up during the sea journey Zₙ and Zₙ₊₂ than during the port lay time Zₙ₊₁.

The task schedule 180 presented in FIG. 2 may be, e.g., an initial task schedule predefined by a land station for the ship. Likewise, the task schedule presented may be an updated task schedule, which may be adapted, e.g., due to the occurrence of an unforeseen event on the ship route of the ship by the processing means of the ship by means of a model on the basis of the initial task schedule so as to maintain operation of the ship while incorporating the unexpected event. Thus, the task schedule 180 of the updated ship itinerary may deviate from the task schedule 180 of the initial ship itinerary.

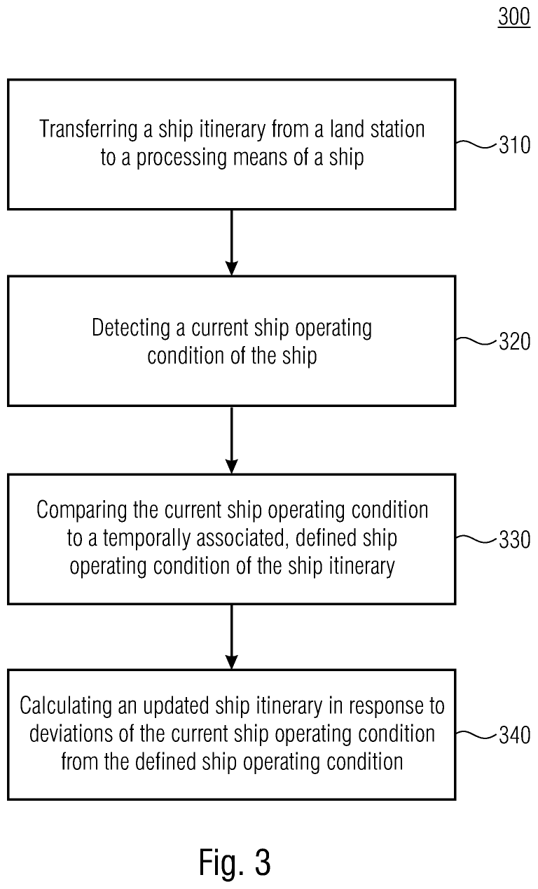

FIG. 3 shows a block diagram of a method 300 of operating a ship which comprises the step of transmitting 310 of a ship itinerary from a land station to a processing means of the ship. The ship itinerary includes one or more defined ship operating conditions for one or more sections of a journey of the ship. Optionally, the ship itinerary may depend on a ship route.

During the journey, the method 300 detects 320 a current ship operating condition of the ship. The current ship operating condition is temporally associated with one of the defined ship operating conditions of the ship itinerary. Optionally, the current ship operating condition may be detected by means of an interface of the processing means with an electronic sea map, with machine sensors, with working-hour terminals of the crew, and with the land station. The current ship operating condition may comprise current and future working hours and tasks of the crew, current states of machines, current and future positions of the ship, and external influences. In accordance with an embodiment, the current ship operating condition may be detected at specific points in time or upon events.

The method 300 compares the current ship operating condition to the temporally associated, defined ship operating condition of the ship itinerary as of 330 so as to calculate 340 an updated ship itinerary in response to deviations of the current ship operating condition from the defined ship operating condition. Calculation 340 of the updated ship itinerary may be based on a model which takes into account operation-relevant parameters for operating the ship. In addition, the updated ship itinerary may comprise a task schedule for the crew of the ship for the journey. In accordance with an embodiment, the operation-relevant parameters of the model may comprise maintenance times, seafaring times, port lay times and safety-relevant parameters such as crew resting periods. In the calculation 340, the model may violate the safety-relevant parameter “crew resting periods” in an exceptional state in order to maintain operation of the ship. In accordance with an embodiment, calculating 340 the updated ship itinerary may comprise adapting at least one of the operation-relevant parameters on the basis of the deviations of the current ship operating condition from the defined ship operating condition of the ship itinerary. Moreover, the model may take into account whether tasks of the task schedule for the crew may be temporally split up and/or may be split up among several crew members. In accordance with an embodiment, calculating 340 the updated ship itinerary on the basis of the model may be effected within less than five minutes upon ascertainment of the deviations of the current ship operating condition from the defined ship operating condition of the ship itinerary.

There are various triggers for changes in the ship operating condition of a ship. In the following examples, two types will be considered; changes triggered by the land station and changes triggered by the ship.

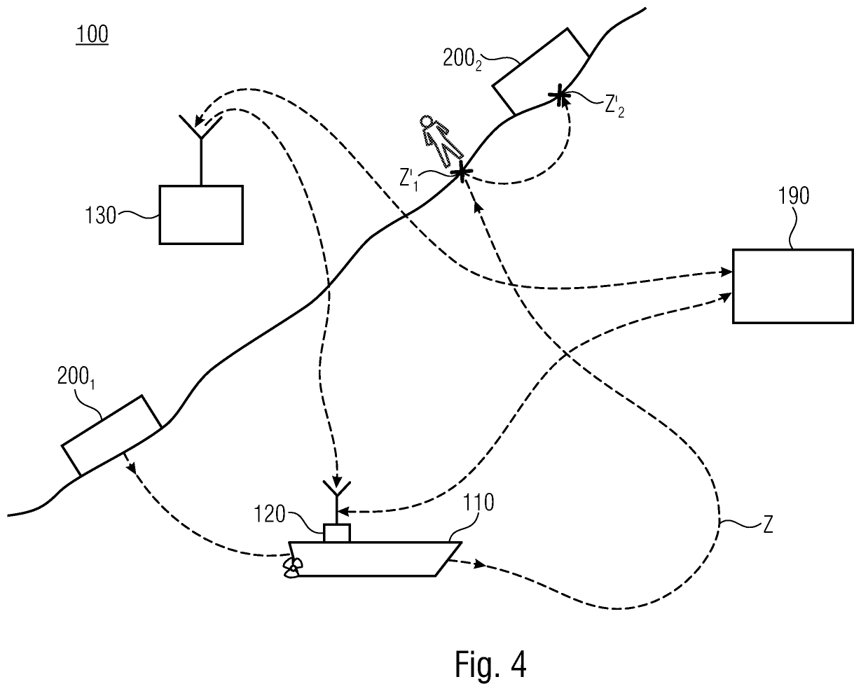

FIG. 4 shows the device 100 in operation. In accordance with a ship itinerary, which may be transmitted from a land station 130 to a processing means 120 of a container ship 110, e.g. via radio, the container ship 110 travels from Bremerhaven 200₁ to Rotterdam 200₂, for example. The ship itinerary comprises, e.g., one single section Z of the journey of the ship 110. In terms of time, the section includes, e.g., one entire day and is dated Sep. 23, 2018. There are two defined ship operating conditions Z′₁ and Z′₂ within this section Z. A first defined ship operating condition Z′₁ is dated, e.g., at 9 a.m. and includes a pilot boarding the ship 110 so as to have the ship 110 safely dock into the port of Rotterdam 200₂ on time. A second defined ship operating condition Z′₂ is dated, e.g., at 10 a.m. and concerns an envisaged time of arrival in Rotterdam 200₂. The scheduled time of arrival in Rotterdam is stored, e.g., in an electronic map system 190.

At 7:30 a.m., the land station 130 transmits an updated journey into the electronic map system 190, according to which the arrival in Rotterdam 200₂ and, thus, also the taking over of the pilot are delayed by three hours in each case. According to the new journey, the ship 110 is to drop anchor shortly before Amsterdam at 8:30 a.m. and to wait for the delayed pilot. The current ship operating condition results from said data of the journey, which has been transmitted from the land station 130 to the electronic sea map 190; the current ship operating condition may be detected, for example, via an interface of the processing means 120 with the sea map 190.

For example, the current ship operating condition includes a time period as of detection (e.g. 7:30 a.m.) of the current ship operating condition up to the arrival in Rotterdam 200₂. Thus, the current ship operating condition may be temporally associated both with the first defined ship operating condition Z′₁ and with the second defined ship operating condition Z′₂ since both defined ship operating conditions lie within the time period of the current ship operating condition. In a comparison of the current ship operating condition to the temporally associated, defined ship operating conditions Z′₁ and Z′₂ of the ship itinerary, the processing means 120 may ascertain deviations, on the basis of which the processing means 120 calculates an updated ship itinerary, which redistributes tasks for safe and smooth operation of the ship system, for example. Said distribution is triggered, for example, by a change in the electronic sea map 190 (e.g. in the electronic charge display and information system, ECDIS), and is facilitated by the device 100, specifically such that hours previously worked by the seafarers (crew) on board the ship 110 are incorporated, e.g., in the task distribution, and that, simultaneously, the resting periods (e.g. crew resting periods) are guaranteed and that, thus, e.g. a new task schedule is calculated by the device 100.

By means of FIG. 4, an alternative example of applying the device 100 will be explained. In this embodiment, the second defined ship operating condition Z′₂ may additionally comprise the information that the ship 110 has a port lay time of twelve hours in Rotterdam 200₂, that within said twelve hours, x containers are to be reloaded, and that stocking of provisions is scheduled at this port.

New information about the journey may be sent from the land station 130 into the electronic map system 190. Said new information may comprise, e.g., a change in the number of containers to be reloaded, and information that the ship 110 is to be refueled for ten hours in Rotterdam 200₂. Thus, the current operating condition (y instead of x containers are to be reloaded, and the ship is to be refueled for ten hours in Rotterdam 200₂) deviates from a temporally associated, defined ship operating condition Z′₂. Thus, the operating condition of the ship 110 has changed even though the schedule (the port lay time) has not changed. The new tasks have to be incorporated into the updated ship itinerary, specifically in such a manner that all other tasks that need to be performed can be performed without any restriction and violation of the resting period and of the operation of the ship. This redistribution is automatically effected by the device.

In accordance with an embodiment, the device 100 is not limited to redistributing tasks for the operation of the ship, but may also be configured to automatically calculate time intervals for maintenance work to be done on machines of the ship 110. In this manner, maintenance work for critical systems may be planned in a better way and may be temporally brought forward or postponed, if need be, without having to negatively change the operating condition of the ship 110.

Thus, the device 100 is configured to perform changes made by the land station 130 (e.g. arrival times), changes of the landing operations in the port, and planning of the maintenance works.

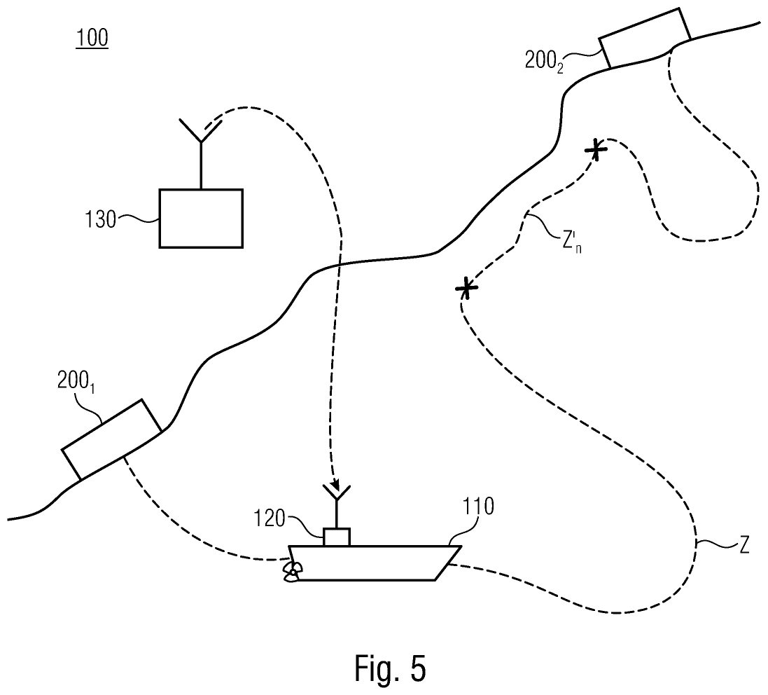

FIG. 5 shows a further embodiment of a device 100 in operation. In accordance with a ship itinerary that was transmitted from a land station 130 to a processing means 120 of a ship 110, the ship 110 travels from Djibouti 200₁ to South Africa 200₂. It is 10 a.m., and according to the ship itinerary, the ship 110 will travel, starting in six hours' time, off the coast of Somalia for ten hours Z′ₙ. Thus, the ship itinerary includes, for a section Z of the journey of the ship 110, a defined ship operating condition Z′ₙ stating that the ship 110 will travel off the coast of Somalia from 4 p.m. to 2:00 a.m. of the next day.

At 12 p.m., a new journey may be transmitted from, e.g., the land station 130 to the processing means 120 of the ship 110. Said new journey includes, e.g., the same geographic waypoints with the same schedule as in the ship itinerary, however, the safety requirements for the sea area off the coast of Somalia have been changed. The area has been categorized in a higher class of risk because of piracy events of the day before. The land station 130 asks that more seafarers than before be on duty alarm at the same time. The ship operating condition has changed, and in order to guarantee safety, a new task distribution may be performed as fast as possible by the device 100 so as to ensure operation of the ship 110.

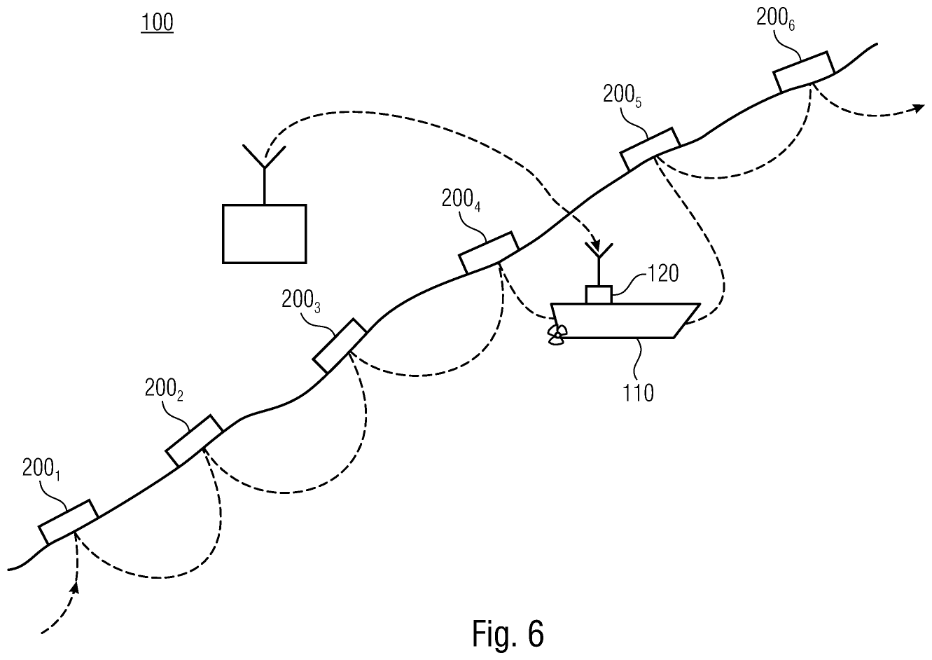

FIG. 6 shows a further embodiment of the device 100 in operation. A container ship 110 travels a very dense series of ports 200₁ to 200₆ in Southeast Asia, which entails a high workload on the entire crew. The hours worked by all seafarers are automatically detected on board, e.g., by an interface of a processing means 120 of the device 100 with working-hour terminals of the crew. Overstepping of a defined tolerance limit of the crew signals, e.g., a change in the operating condition of the ship 110 and thus triggers adaption of the task distribution so as to guarantee that the safety requirement will be met for the new condition. For example, the device 100 may give crew members which have hit their tolerance limit a crew resting period and may assign tasks for ensuring operation of the ship 110 that are to be accomplished at this point in time to other crew members instead of the formerly mentioned crew members.

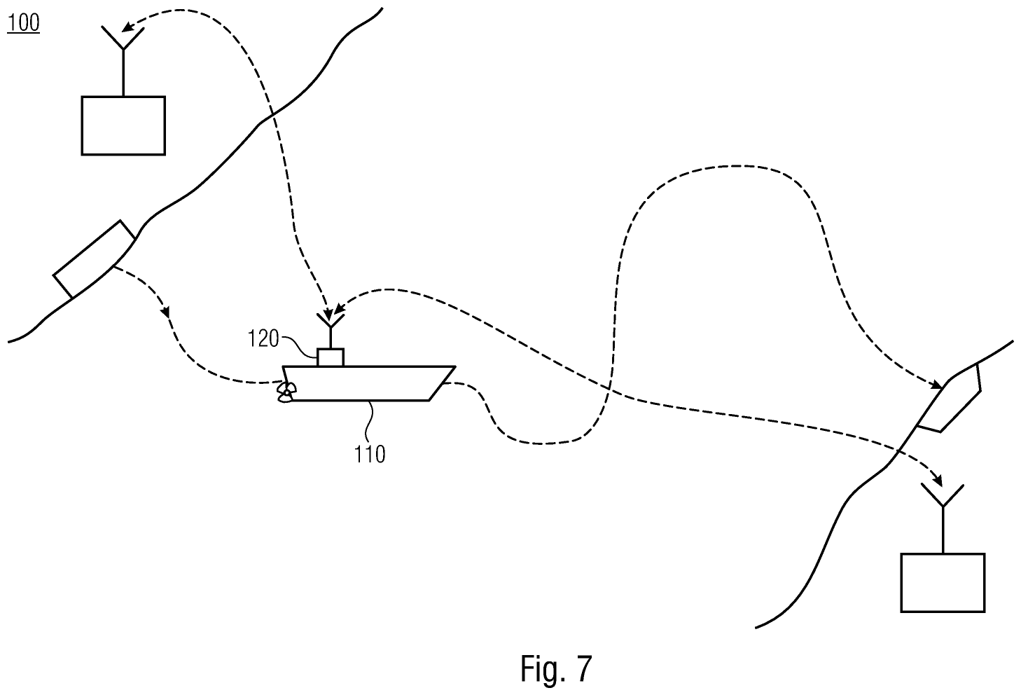

FIG. 7 shows an embodiment of a device 100 in operation. In accordance with a ship itinerary, a ship 110 travels from Europe to North America. During the crossing, an emergency signal may be automatically triggered that is due to a fire in the cargo hold. The ship operating condition has changed, of course. A task distribution for mastering the emergency and for navigating the ship at the same time may be available as fast as possible. With the automatic trigger of the emergency, said exceptional state is automatically taken over by the device 100 and is taken into account by a processing means 120 in calculating an updated ship itinerary. Thus, the device 100 is configured to maintain operation of the ship 110 even in unexpected extreme situations.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device. Some or all of the method steps may be performed by a hardware device (or while using a hardware device) such as a microprocessor, a programmable computer or an electronic circuit, for example. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or actually do cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium or the computer-readable medium are typically concrete and/or non-transitory and/or non-transient.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU) or a hardware specific to the method, such as an ASIC.

The devices described herein or any components of the devices described herein may be implemented, at least partly, in hardware or in software (computer program).

The devices described herein may be implemented, e.g, while using a hardware apparatus or while using a computer or while using a combination of a hardware apparatus and a computer.

The methods described herein or any components of the devices described herein may be executed, at least partly, by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Method of operating a ship, comprising:
acquiring a ship itinerary by means of a processing unit of the ship, the ship itinerary comprising one or more defined ship operating conditions for one or more sections of a journey of the ship;
during the journey, detecting a current ship operating condition of the ship, the current ship operating condition being temporally associated with one of the defined ship operating conditions of the ship itinerary, and wherein the current ship operating condition is detected by means of an interface of the processing unit with an electronic sea map, with machine sensors, with working-hour terminals of the crew, and/or with the land station; and
wherein the one or more defined ship operating conditions and the current ship operating condition comprise states of machines, current and/or future positions of the ship, and/or external influences;
comparing the current ship operating condition to the temporally associated, defined ship operating condition of the ship itinerary so as to calculate an updated ship itinerary in response to deviations of the current ship operating condition from the defined ship operating condition,
wherein calculating the updated ship itinerary is based on a model which takes into account operation-relevant parameters for the operation of the ship;
wherein the ship itinerary and/or the updated ship itinerary comprises a task schedule for a crew of the ship for the journey, and
wherein the model takes into account maintenance times, so that the task schedule for the crew of the ship indicates maintenance times that may be performed on the machines of the ship.

2. Method as claimed in claim 1, the method comprising transmitting a ship itinerary from a land station to a processing unit of the ship.

3. Method as claimed in claim 1, wherein the operation-relevant parameters of the model comprise maintenance times, seafaring times, port lay times and/or safety-relevant parameters such as crew resting periods.

4. Method as claimed in claim 3, wherein the model is configured to allow, in an exceptional state, deviations from the safety-relevant parameter “crew resting periods” so as to maintain operation of the ship.

5. Method as claimed in claim 1, wherein at least one of the operation-relevant parameters is adapted on the basis of a deviation of the current ship operating condition from the defined ship operating condition of the ship itinerary.

6. Method as claimed in claim 1, wherein the model takes into account whether or not tasks of the task schedule for the crew may be temporally split up and/or be split up among several crew members.

7. Method as claimed in claim 1, wherein calculation of the updated ship itinerary on the basis of the model is effected within less than five minutes upon ascertainment of the deviations of the current ship operating condition from the defined ship operating condition of the ship itinerary.

8. Method as claimed in claim 1, wherein the current ship operating condition comprises current and/or future working hours and/or tasks of the crew.

9. Method as claimed in claim 1, wherein the current ship operating condition is detected at specific points in time or upon events.

10. Method as claimed in claim 1, wherein the ship itinerary and/or the updated ship itinerary depends on a ship route.

11. Method of operating a ship, comprising:
transmitting a ship itinerary from a land station to a processing unit of the ship, the ship itinerary comprising one or more defined ship operating conditions for one or more sections of a journey of the ship;
during the journey, detecting a current ship operating condition of the ship, the current ship operating condition being temporally associated with one of the defined ship operating conditions of the ship itinerary, and wherein the current ship operating condition is detected by means of an interface of the processing unit with an electronic sea map, with machine sensors, with working-hour terminals of the crew, and/or with the land station; and
wherein the one or more defined ship operating conditions and the current ship operating condition comprise states of machines, current and/or future positions of the ship, and/or external influences;
comparing the current ship operating condition to the temporally associated, defined ship operating condition of the ship itinerary so as to calculate an updated ship itinerary in response to deviations of the current ship operating condition from the defined ship operating condition,
wherein calculating the updated ship itinerary is based on a model which takes into account operation-relevant parameters for the operation of the ship, and
wherein the ship itinerary and the updated ship itinerary comprise a task schedule for a crew of the ship for the journey, and
wherein the model takes into account maintenance times, so that the task schedule for the crew of the ship indicates maintenance times that may be performed on the machines of the ship.

12. A non-transitory digital storage medium having a computer program stored thereon to perform the method of operating a ship, said method comprising:
acquiring a ship itinerary by means of a processing unit of the ship, the ship itinerary comprising one or more defined ship operating conditions for one or more sections of a journey of the ship;
during the journey, detecting a current ship operating condition of the ship, the current ship operating condition being temporally associated with one of the defined ship operating conditions of the ship itinerary, and wherein the current ship operating condition is detected by means of an interface of the processing unit with an electronic sea map, with machine sensors, with working-hour terminals of the crew, and/or with the land station; and
wherein the one or more defined ship operating conditions and the current ship operating condition comprise states of machines, current and/or future positions of the ship, and/or external influences;
comparing the current ship operating condition to the temporally associated, defined ship operating condition of the ship itinerary so as to calculate an updated ship itinerary in response to deviations of the current ship operating condition from the defined ship operating condition,
wherein calculating the updated ship itinerary is based on a model which takes into account operation-relevant parameters for the operation of the ship;
wherein the ship itinerary and/or the updated ship itinerary comprises a task schedule for a crew of the ship for the journey, and
wherein the model takes into account maintenance times, so that the task schedule for the crew of the ship indicates maintenance times that may be performed on the machines of the ship,
when the program runs on a computer.

13. Device for operating a ship, comprising:
a processing unit of the ship that is configured
to acquire a ship itinerary, the ship itinerary comprising one or more defined ship operating conditions for one or more sections of a journey of the ship;
to detect, during the journey, a current ship operating condition of the ship, the current ship operating condition being temporally associated with one of the defined ship operating conditions of the ship itinerary; and
to detect the current ship operating condition by means of an interface with an electronic sea map, with machine sensors, with working-hour terminals of the crew, and/or with the land station; and
wherein the one or more defined ship operating conditions and the current ship operating condition comprise states of machines, current and/or future positions of the ship, and/or external influences;
to compare the current ship operating condition to the temporally associated, defined ship operating condition of the ship itinerary so as to calculate an updated ship itinerary in response to deviations of the current ship operating condition from the defined ship operating condition,
the device being configured to calculate the updated ship itinerary on the basis of a model which takes into account operation-relevant parameters for the operation of the ship;
wherein the ship itinerary and/or the updated ship itinerary comprises a task schedule for a crew of the ship for the journey, and
wherein the model takes into account maintenance times, so that the task schedule for the crew of the ship indicates maintenance times that may be performed on the machines of the ship.

14. Device for operating a ship, comprising:
a processing unit of the ship that is configured
to acquire a ship itinerary, the ship itinerary comprising one or more defined ship operating conditions for one or more sections of a journey of the ship;
to detect, during the journey, a current ship operating condition of the ship, the current ship operating condition being temporally associated with one of the defined ship operating conditions of the ship itinerary, and
to detect the current ship operating condition by means of an interface with an electronic sea map, with machine sensors, with working-hour terminals of the crew, and/or with the land station; and
wherein the one or more defined ship operating conditions and the current ship operating condition comprise states of machines, current and/or future positions of the ship, and/or external influences;
to compare the current ship operating condition to the temporally associated, defined ship operating condition of the ship itinerary so as to calculate an updated ship itinerary in response to deviations of the current ship operating condition from the defined ship operating condition,
the device being configured to calculate the updated ship itinerary on the basis of a model which takes into account operation-relevant parameters for the operation of the ship, and
wherein the ship itinerary and the updated ship itinerary comprise a task schedule for a crew of the ship for the journey, and
wherein the model takes into account maintenance times, so that the task schedule for the crew of the ship indicates maintenance times that may be performed on the machines of the ship.

15. Ship comprising a device for operating a ship, said device comprising:
a processing unit of the ship that is configured
to acquire a ship itinerary, the ship itinerary comprising one or more defined ship operating conditions for one or more sections of a journey of the ship;
to detect, during the journey, a current ship operating condition of the ship, the current ship operating condition being temporally associated with one of the defined ship operating conditions of the ship itinerary; and
to detect the current ship operating condition by means of an interface with an electronic sea map, with machine sensors, with working-hour terminals of the crew, and/or with the land station; and
wherein the one or more defined ship operating conditions and the current ship operating condition comprise states of machines, current and/or future positions of the ship, and/or external influences;
to compare the current ship operating condition to the temporally associated, defined ship operating condition of the ship itinerary so as to calculate an updated ship itinerary in response to deviations of the current ship operating condition from the defined ship operating condition,
the device being configured to calculate the updated ship itinerary on the basis of a model which takes into account operation-relevant parameters for the operation of the ship;
wherein the ship itinerary and/or the updated ship itinerary comprises a task schedule for a crew of the ship for the journey, and
wherein the model takes into account maintenance times, so that the task schedule for the crew of the ship indicates maintenance times that may be performed on the machines of the ship.
